(19) United States
(12) Patent Application Publication
(10) Pub. No.: US 2021/0090433 A1
(43) Pub. Date: Mar. 25, 2021

(54) Transportation system and method

(71) Applicant: John Van Egmond, Brampton, CA (US)

(72) Inventor: John Van Egmond, Brampton, CA (US)

(21) Appl. No.: 17/112,256

(22) Filed: Dec. 4, 2020

Related U.S. Application Data
(63) Continuation of application No. 15/698,149, filed on Sep. 7, 2017, now abandoned.
(60) Provisional application No. 62/394,248, filed on Sep. 14, 2016.

(51) Int. Cl. G08G 1/01; G08G 1/017; G08G 1/015; G08G 1/00; H04W 4/02; G06F 21/44; G05D 1/02

(52) U.S. Cl. CPC G08G 1/0112; G08G 1/017; G08G 1/015; G08G 1/207; G08G 1/127; G08G 1/0145; G06F 21/44; G05D 1/0297; G08G 1/0137; H04W 4/027

(57) ABSTRACT

A transportation system on earth comprising a defined transportation universe having defined contents (real or virtual) and a defined transportation universe boundary (real or virtual). There is a central control system for controlling the transportation universe. A plurality of vehicles have a vehicle identification unit used by the central control system and connectable in two-way data communication with the central control system and can therefore become a transportation universe controlled vehicle. Each vehicle in the transportation universe is controlled by the central computer system interacting with the identification unit in the vehicle. Each vehicle is motor powered so as to be movable within the transportation universe under the control of the central control system. Each of the vehicles can enter into the transportation universe through the transportation universe boundary at one of a plurality of entry points and can exit from the transportation universe through the transportation universe boundary at one of a plurality of exit points. The entry of each vehicle into the transportation universe is controlled solely and totally by the central control system. Each of the plurality of vehicles that enters into and exits from the transportation universe boundary travels a journey between the entry point and the exit point. Each vehicle is controlled along the journey along with each other vehicle when in the transportation universe to thereby provide full control of traffic in the transportation universe.

### CROSS REFERENCE TO RELATED APPLICATION

This application is a Continuation of and claims the filing benefit under 35 U.S.C. § 120 of application Ser. No. 15/698,149 filed Sep. 7, 2017, which is hereby incorporated by reference. This application also claims the filing benefit under 35 U.S.C. § 119(e) of U.S. Provisional Application No. 62/394,248 filed Sep. 14, 2016 which is hereby incorporated by reference.

### FIELD OF INVENTION

The present invention relates to transportation systems, and more particularly to transportation systems wherein the vehicles within a transportation universe are centrally controlled by an optimization function

### BACKGROUND OF INVENTION

The modern vehicle and transportation system is chaotic, large and complex. Annually millions of people are injured, about 2 people per second are killed, and trillions of dollars of damage are done. As such the background herein is limited in scope as the system is well known.

The transportation system for land based systems is characterized by roads, informational devices on the roads, vehicles powered by various energy sources (though predominantly fossil fuels), human drivers, vehicles with safety features (brakes, windows, windshield wipers, speedometers, assistive devices such as cruise control, etc.), laws, policy, etc. For non land based systems similar situations arise. To a smaller part autonomous and driverless vehicles which require computers for complex decision making and interaction in a chaotic transportation system are becoming present.

Piloted, autonomous vehicles and other vehicles include safety features related to protecting against accidents and human traumas. The current system is a system of avoidance and competition.

Further, space within the transportation system is poorly used in the way of gaps, bidirectional or multidirectional lanes, intersection, stopping and so on. The transportation system on ground is characterized by informative tools (signs, strips, fences, etc.) to guide users or to hard construct in safety measures. Windshields, windshield wipers, bumpers, advertising signs, law enforcement tools, insurance tools, pavement types, barrier types, signalization, and a host of other tools exist in the vehicle and in the chaotic transportation systems which are not further enumerated herein.

To address safety issues for high speed vehicles and to reduce the interaction of traffic with cross purposes, controlled highways limit access to closed moving vehicles, controlled by means of fences, toll gates, ramps, laws and law enforcement.

The existing fleet of vehicles can include vehicles from almost any era, from horse and carriage to piloted (human or autonomous) vehicles. Many vehicles using the road are decades old.

### Technical Problem

Current vehicles on land in urban, rural and wild (off-road) settings are piloted and used by humans or autonomous systems to safely navigate to destinations. The pilot (human or computer) must obey traffic laws, navigate safely in the a chaotic transportation system, understand and react to signs, understand and react to signalization, understand and respond to other pilots, understand and react to the signals of other vehicles, and treat other vehicles and obstacles and humans as antagonistic to the optimal route to a destination and to the pilot and to other occupant safety.

Autonomous vehicles currently cannot fully replace the human pilot who needs to be able to override the controls (such as steering or braking). Even future autonomous vehicles may suffer from these needs. The current vehicle pilot (human or autonomous) operates in a transportation system which experiences many negative outcome interactions which result in injury, death, loss, lost time, wasted energy and wasted greenhouse gas expenditures. The system relies on owners maintaining the thousands of components of the vehicles they own. The system relies on owners maintaining roadways and corridors. The results of negative outcomes are injuries, death, lost time, family grief, loss of income, and other losses such as economic losses which must be insured against.

Further, within the pilot pool and the chaotic transportation system are subversive impaired and distracted drivers who increase the overall chaos and damage. The overarching technical problem is that in the chaotic transportation system the vehicle represents a single unit, protecting itself with diligence and technology from other vehicles in a chaotic transportation system, making all others targets of irrational fears and actions to even the extent of road rage. Further the driver pool includes inexperienced pilots and pilots with diminishing capacity.

### Solution to Technical Problem

The solution to the technical problem is to make a transportation universe with vehicles, the roads, the rights of ways, the ancillary fixtures, and users within it unitary in nature. The invention as disclosed herein sets out the tools and methods of a transportation universe that fully and solely controls movements of vehicles in the universe.

### BRIEF SUMMARY OF THE INVENTION

In accordance with one aspect of the present invention there is disclosed a novel transportation system comprising a defined transportation universe having defined contents and a defined transportation universe boundary. There is a central control system for controlling the transportation universe using a control function Fn(xi,yi,zi,fi,ti,. . . . ). A plurality of vehicles have a vehicle identification unit for use by the central control system and connectable in two-way data communication with the central control system and is therefore a controlled vehicle. Each vehicle in the transportation universe is controlled by the central computer system interacting with the movement control devices in the vehicle. Each vehicle is motor powered so as to be movable within the transportation universe under the control of the central control system. Each of the vehicles can become attached to and under the central control through the transportation universe boundary at one of a plurality of entry points and can exit from the transportation universe through the transportation universe boundary at one of a plurality of exit points. The entry of each vehicle into the transportation universe is controlled by the central control system. Each of the plurality of vehicles that enters into and exits from the transportation universe boundary travels a journey between the entry point and the exit point, where the entry points and boundaries may be real or virtual. Each vehicle is controlled along the journey in conjunction with all other in universe vehicles to thereby provide fully control of traffic in the transportation universe.

In accordance with another aspect of the present invention there is disclosed a novel transportation method comprising the steps of defining a transportation universe including contents thereof and a defined transportation universe boundary; programming a function, Fn(xi,yi,zi,fi,ti, . . . ), into the central control system to control the transportation universe by means of; providing a plurality of vehicles with a vehicle identification unit for use by said central control system and connectable in two-way data communication with said central control system, such that said vehicles become fully controlled vehicles, wherein each vehicle is motor powered and equipped with control equipment so as to be movable within the transportation universe under the sole and total control of said central control system; controlling each vehicle in the transportation universe using said central computer system; permitting each of said vehicles to enter into the transportation universe through the transportation universe boundary at one of a plurality of entry points and to exit from the transportation universe through the transportation universe boundary at one of a plurality of exit points; wherein each of said plurality of vehicles that enters into and exits from the transportation universe boundary travels a journey between said entry point and said exit point; and controlling each of said vehicles along said journey in co-operation with each other vehicle when in the transportation universe to thereby provide full control of traffic in said transportation universe.

In accordance with another aspect of the present invention there is disclosed a novel computer system comprising one or more servers programmed to communicate with a plurality of vehicles over a communication link for effecting full control of traffic in a transportation universe, the one or more servers comprising at least one data processor configured using a control function (Fn(xi,yi,zi,fi,ti, . . . ) to define a transportation universe including real or virtual contents thereof and a defined real or virtual transportation universe boundary; to control the transportation universe via a central control system; to authorize a plurality of vehicles with having a vehicle identification unit and connectable in two-way data communication with said central control system, such that said vehicles become controlled vehicles, wherein each controlled vehicle is motor powered so as to be movable within the transportation universe under the control of said central control system; to control each vehicle in the transportation universe using said central computer system; to permit each of said vehicles to enter into the transportation universe through the transportation universe boundary at one of a plurality of entry points and to exit from the transportation universe through the transportation universe boundary at one of a plurality of exit points; wherein each of said plurality of vehicles that enters into and exits from the transportation universe boundary travels a journey between said entry point and said exit point under the full and sole control of the transportation universe in co-operation with each other vehicle when in the transportation universe to thereby provide full control of vehicles, vehicle movements, and traffic in the transportation universe.

In accordance with another aspect of the present invention there is disclosed a novel transportation system comprising a defined transportation universe having defined contents (real or virtual) and a defined transportation universe boundary (real or virtual). There is a central control system for controlling the transportation universe. Vehicles in the transportation universe have a vehicle identification unit used by the central control system and connectable in two-way data communication with the central control system and is therefore a controlled vehicle. Each vehicle in the transportation universe is fully controlled by the central computer system interacting with the identification unit and movement control devices in the vehicle. Each vehicle is motor powered so as to be movable within the transportation universe under the control of the central control system. Each of the vehicles can enter into the transportation universe through the transportation universe boundary at one of a plurality of entry points and can exit from the transportation universe through the transportation universe boundary at one of a plurality of exit points. The entry of each vehicle into the transportation universe is used by the central control system. Each of the plurality of vehicles that enters into and exits from the transportation universe boundary travels a journey between the entry point and the exit point. For a predefined path, each vehicle on the predefined pathway is maintained at a predetermined speed to thereby maximize the amount of traffic flow on that predefined path and to achieve other goals (safety, greenhouse gas reduction, etc.)

In accordance with another aspect of the present invention there is disclosed a novel transportation method comprising the steps of defining a transportation universe including contents thereof and a defined transportation universe boundary; programming a function, Fn(xi,yi,zi,fi,ti, . . . ), for the central control system to control the transportation universe; providing a plurality of vehicles with vehicle identification units used by said central control system and connectable in two-way data communication with said central control system, such that said vehicles become controlled vehicles, wherein each vehicle is motor powered so as to be movable within the transportation universe under the control of said central control system using on board movement control devices; controlling each vehicle in the transportation universe using said central computer system; permitting each of said vehicles to enter into the transportation universe through the transportation universe boundary at one of a plurality of entry points and to exit from the transportation universe through the transportation universe boundary at one of a plurality of exit points; wherein each of said plurality of vehicles that enters into and exits from the transportation universe boundary travels a journey between said entry point and said exit point; and for a predefined pathway, maintaining the speed of each vehicle on said predefined pathway at an optimal speed to thereby maximize the amount of traffic flow on that predefined path.

In accordance with another aspect of the present invention there is disclosed a novel computer system comprising one or more servers programmed to communicate with a plurality of vehicles over a communication link for effecting full control of traffic in a transportation universe, the one or more servers comprising at least one data processor configured by the function Fn(xi,yi,zi,fi,ti, . . . ) to define a transportation universe including contents thereof and a defined transportation universe boundary; control the transportation universe via a central control system; authorize a plurality of vehicles with having a vehicle identification unit and connectable in two-way data communication with said central control system, such that said vehicles become controlled vehicles, wherein each controlled vehicle is motor powered so as to be movable within the transportation universe under the control of said central control system; control each vehicle in the transportation universe using said central computer system; permitting each of said vehicles to enter into the transportation universe through the transportation universe boundary at one of a plurality of entry points and to exit from the transportation universe through the transportation universe boundary at one of a plurality of exit points; wherein each of said plurality of vehicles that enters into and exits from the transportation universe boundary travels a journey between said entry point and said exit point; and maintain the speed of each vehicle along its journey on a predefined pathway at a predetermined minimum speed to thereby maximize the amount of traffic flow on that predefined path.

In accordance with another aspect of the present invention there is disclosed a novel transportation system comprising a defined transportation universe having defined contents and a defined transportation universe boundary. There is a central control system for controlling the transportation universe. A plurality of vehicles have a vehicle identification unit controlled by the central control system and connectable in two-way data communication with the central control system and is therefore controlled vehicle. Each vehicle in the transportation universe is controlled by the central computer system interacting with the identification unit in the vehicle. Each vehicle is motor powered so as to be movable within the transportation universe under the control of the central control system which system communicates to and use on vehicle movement control devices. Each of the controlled vehicles can enter into the transportation universe through the transportation universe boundary at one of a plurality of entry points and can exit from the transportation universe through the transportation universe boundary at one of a plurality of exit points. The entry of each vehicle into the transportation universe is controlled by the central control system. Each of the plurality of vehicles that enters into and exits from the transportation universe boundary travels a journey between the entry point and the exit point. The central control system can allocate and reallocate the purpose of a predefined pathway in the transportation universe.

In accordance with another aspect of the present invention there is disclosed a novel transportation method comprising the steps of defining a transportation universe including contents thereof and a defined transportation universe boundary; programming a central control system to control the transportation universe; providing a plurality of vehicles with a vehicle identification unit used by said central control system and connectable in two-way data communication with said central control system, such that said vehicles become controlled vehicles, wherein each vehicle is motor powered so as to be movable within the transportation universe under the control of said central control system; controlling each vehicle in the transportation universe using said central computer system; permitting each of said vehicles to enter into the transportation universe through the transportation universe boundary at one of a plurality of entry points and to exit from the transportation universe through the transportation universe boundary at one of a plurality of exit points; wherein each of said plurality of vehicles that enters into and exits from the transportation universe boundary travels a journey between said entry point and said exit point; and for a predefined path, allocating and reallocating the purpose of a predefined pathway in the transportation universe.

In accordance with another aspect of the present invention there is disclosed a novel computer system comprising one or more servers programmed to communicate with a plurality of vehicles over a communication link for effecting fully control of traffic in a transportation universe, the one or more servers comprising at least one data processor configured to define a transportation universe including contents (real or virtual) thereof and a defined transportation universe boundary (real or virtual); control the transportation universe via a central control system; authorize a plurality of vehicles with having a vehicle identification unit and connectable in two-way data communication with said central control system, such that said vehicles become controlled vehicles, wherein each vehicle is motor powered so as to be movable within the transportation universe under the control of said central control system; control each vehicle in the transportation universe using said central computer system; permit each of said vehicles to enter into the transportation universe through the transportation universe boundary at one of a plurality of entry points and to exit from the transportation universe through the transportation universe boundary at one of a plurality of exit points; wherein each of said vehicles that enters into and exits from the transportation universe boundary travels a journey between said entry point and said exit point; and the universe which solely allocates and reallocates the purpose of a predefined pathway in the transportation universe.

The present invention is for vehicle control and movement in a defined transportation universe (TU) for the vehicle. The invention includes a planning tool on board vehicles and as part of the Transportation Universe to direct vehicles from an origin or origins to a destination or destinations without human intervention. The invention establishes a Transportation Universe. The invention has an interface to allow humans to specify an origin or origins to a destination or destinations.

The present invention is for static elements being added or removed from the transportation universe. A business might wish to add its locations, its parking spaces, its access points to the transportation universe by adding elements such as coordinates, area, and the like. Similarly an owner might add elements to the universe to allow vehicles to arrive and park. These are personal or local universes or zones.

The Transportation universe will use multiple optimization tools to optimize safety, energy, time, maintenance, time. The tools will include mathematical and scientific algorithms (Fn(xi,yi,zi,fi,ti, . . . ) to achieve user and systems goals.

It is an object of the present invention to provide a transportation universe with vehicles and users that unitary in the nature of vehicle movement control.

It is an object of the present invention to provide a transportation universe and its ancillary tools, methods, and means.

It is an object of the present invention to provide a transportation system and method wherein each vehicle is controlled along each journey by the a control function Fn(xi,yi,zi,fi,ti, . . . ) under a central control in co-operation with each other vehicle and the fixtures of the system when in the transportation universe to thereby provide full control of traffic in the transportation universe by the central control function.

It is an object of the present invention to provide a transportation system and method wherein for a given path (e.g. road), each vehicle and its movement on the predefined pathway is maintained at a speed to thereby maximize the amount of traffic flow on that predefined path. The journey along the predefined path may be altered as the goals or needs of the transportation system changes.

It is an object of the present invention to provide a transportation system and method wherein the central control system can allocate and reallocate the purpose of a predefined pathway in the transportation universe using the control Fn(xi,yi,zi,fi,ti. . . . ).

It is an object of the present invention to provide a transportation system and method that is not a system of avoidance and competition.

It is an object of the present invention to provide a transportation system and method transportation system wherein travelled pathways are well used in terms of minimizing gaps, bi-directional of pathways, multidirectional lanes, and efficient intersections.

It is an object of the present invention to provide a transportation system and method wherein humans and autonomous systems are not used to pilot vehicles.

It is an object of the present invention to provide a transportation system and method that is a non-chaotic transportation system.

It is an object of the present invention to provide a transportation system and method wherein other vehicles and obstacles and humans are not treated as antagonistic to the optimal route to a destination and to the pilot and to other occupant safety.

It is an object of the present invention to provide a transportation system and method transportation system that minimizes injury, death, loss, lost time, wasted energy and wasted greenhouse gas expenditures.

It is an object of the present invention to provide a transportation system and method transportation system without subversive impaired and distracted drivers.

It is an object of the present invention to provide a transportation system and method transportation system which system is without vehicle operators (pilots) that are inexperienced or with diminished capacity being in control of vehicles or vehicle movements.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the transportation system and method to the present invention, as to its structure, organization, use and method of operation, together with further objectives and advantages thereof, will be better understood from the following drawings in which a presently known embodiment of the invention will now be illustrated by way of example. It is expressly understood, however, that the drawings are for the purpose of illustration and description only, and are not intended as a definition of the limits of the invention. In the accompanying drawings:

FIG. 1 is a diagrammatic view of a transportation universe and a vehicle within it showing the transportation universe, the universe controlled vehicle (2), the origin of a trip (3), the destination of a trip (4), a route plan (5), a transportation trip allocation device (6), a destination entry device (7), a universe bounding marker (8); and universe content space with boundary (9)

FIG. 2 is an enlarged diagrammatic view of FIG. 1 showing the Transportation Universe with multiple origins (200), destinations (201), vehicles (2), vehicles being aggregated into virtual groups (203) of common destination, and individual paths (5) to the current trip optimum destination path (5);

FIG. 3 is a diagrammatic view of the transportation universe showing definitions of the edges of the transportation universe of FIG. 1 showing multi-parameter function (302) and the transportation trip allocation central control device, and markers within the transportation universe, which markers are included in function Fn(xi,yi,zi,fi,ti. . . . ) (302);

FIG. 4 is a diagrammatic view a vehicle (2) with an attachable personal data and trip device (400) and shows a zone definition device (401) used to define a local universe or zone (402) for attachment to the transportation universe and which informs the transportation universe via the central control or the trip allocation device (6), and showing a local universe or zone marker (303) in the transportation universe, along with the zone (402) within the transportation universe and the direct connections points by way of the markers (303);

FIG. 5 is a diagrammatic view of the vehicle (2), in the zone (402) within the transportation universe (1), with direct connection points by way of the markers (303) also shown, with the direct connection points are at the markers (virtual or real) while the lines connecting the points are defined between the markers and are defined by the control function Fn(xi,yi,zi,fi,ti . . . ) (302). An in universe device for measuring parameters, taking local information, etc. for transmission to the transportation universe is shown (502);

FIG. 6 is a diagrammatic view of the transportation universe (1) having incorporated and connected to owners and regulators (600), and their personal or local universe or zone (602) that is aggregated with other zones into the transportation universe (1);

FIG. 7 is a diagrammatic view of Vehicles (3) and the Transportation Universe, with an environmental conditions station is shown (700), and with a vehicle (702) being part of a group as the vehicle polls by questioning and investigation (701) for road surface conditions from external sources and by such activities as applying brakes, torques, LIDAR distancing, etc. to determine physical conditions and responses, with the data being supplied to the central control (6) and other vehicles on the various paths (5);

FIG. 8 is a diagrammatic view of a vehicle (2) on a road surface (805) with the central control (6) shown receiving and sending data from an onboard data device value or data device (400);

FIG. 9 is a diagrammatic view of a connection of vehicles (2, 902) that are travelling on a road surface (805) with an interceptor connector (900) shown on one vehicle (2) and an approach connector (901) shown on another vehicle (902) and which are each and both under the full control for the transportation universe;

FIG. 10 is a diagrammatic view the interceptor connector (900) and its basic components, the interceptor fitting (1001) which mediates the positioning and the transition assistor (1000) which smoothens the interception and connects to a vehicle (2), and the approach connector (901), the approach fitting (1002) and the approach assistor which smoothens the interception and connects to a vehicle (902) so the transportation control function Fn(xi,yi,zi,fi,ti . . . ) can fully control movements of each vehicle whether independently or as a unit.

FIG. 11 is a diagrammatic view the transportation universe (1) in relation to a number of typical owners (600, 1100, 1102, 1104, and 1106) with the boundaries (real or virtual) of the various owners' jurisdictions shown (602, 1101, 1103, 1105, and 1107); and,

FIG. 12 is a diagrammatic view of a transportation controlled vehicle (2) having an occupancy space (1200) and showing assorted equipment (1201, 1202, 1203, 1204) customizable managed equipment, and also showing an attachable personal data and trip device (400), occupant data and equipment data (1205), and the data connection informing the vehicle of the occupant equipment (1206).

### DETAILED DESCRIPTION OF THE INVENTION

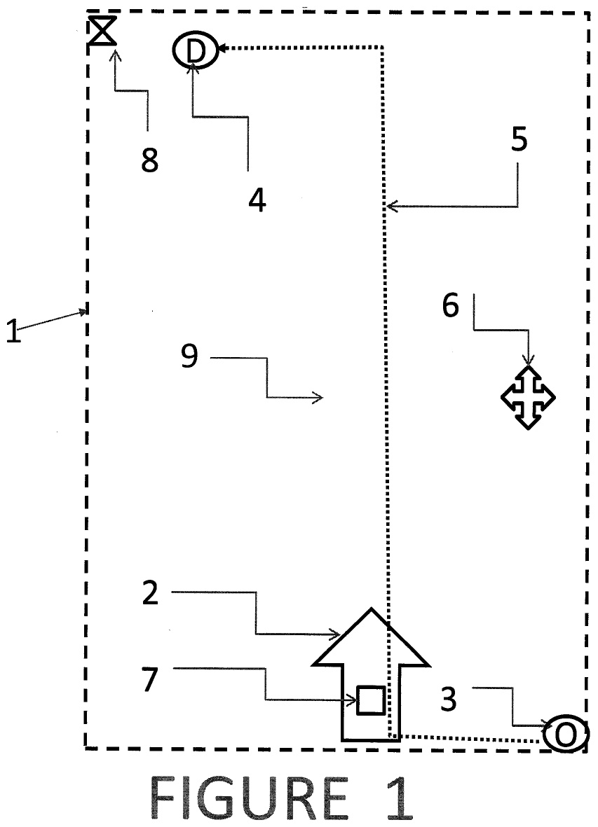

Referring to FIGS. 1 through 12 of the drawings, it will be noted that FIGS. 1 through 12 show a first illustrated embodiment of the transportation system and method according to the present invention.

Reference will now be made to FIGS. 1 through 12, which show a first illustrated embodiment of the present invention. In brief, the first illustrated embodiment of the transportation system (10) comprises a defined transportation universe (1), a central control system (6) (also known as the trip allocation device), a control function control function Fn(xi,yi,zi,fi,ti . . . ), and a plurality of vehicles (2).

FIG. 1 is a view of a transportation universe (1) and a directed vehicle within it showing the transportation universe content (9), the directed vehicle (2), the origin of a trip (3), the destination of a trip (4), a route plan (5), a central control device (6), a destination entry device (7), and a universe bounding marker (real or virtual (8).

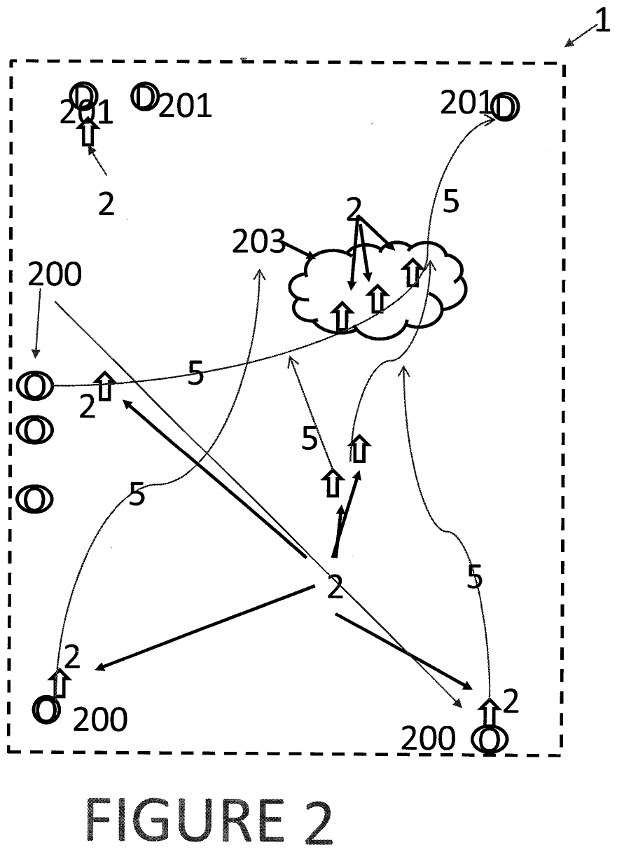

FIG. 2 is an expanded view of FIG. 1 showing the transportation universe with multiple origins (200), destinations (201), vehicles (3), vehicles being aggregated into virtual groups (203) of common destination, and individual paths (5) to the current trip optimum destination path (5).

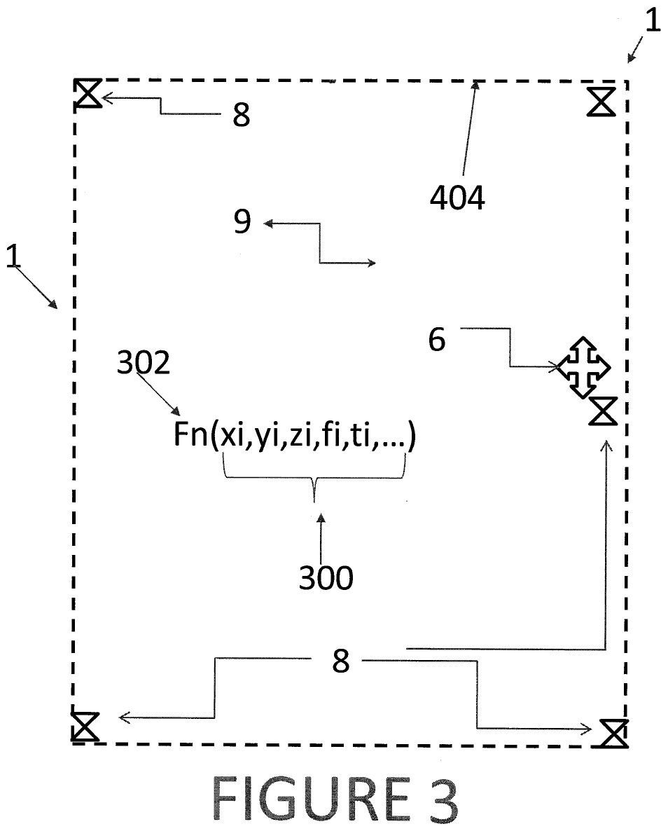

FIG. 3 shows definitions of the edges of the transportation universe of FIG. 1 showing multi-parameter data field (300) and the central control system. FIG. 3 shows markers (real or virtual) within the transportation universe. The markers include function Fn(xi,yi,zi,fi,ti . . . )s (302).

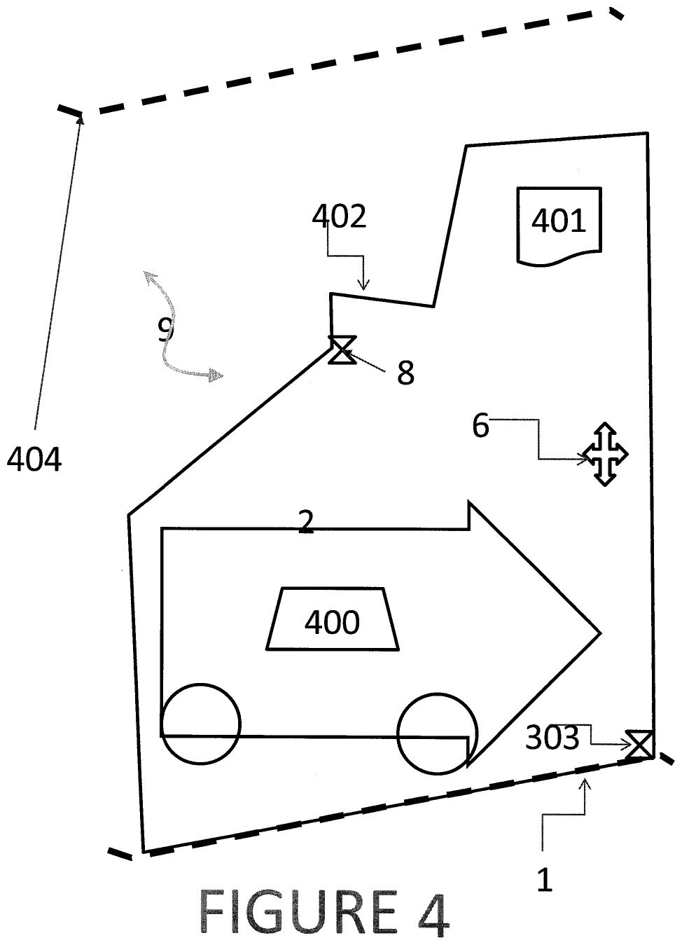

FIG. 4 is a diagrammatic view of a vehicle (2) with an attachable personal data and trip device (400) and shows a definition device (401) used by owners (agencies, renters, leases, etc.) to define a local universe or zone (402) for attachment to the transportation universe and which informs the transportation universe via the central control system (6). A zone marker (real or virtual) (303) in the transportation universe is shown. A boundary (virtual or real) (404) of the transportation universe (1) is shown. Note the boundary (400) is part of the universe but is not the entirety of the universe (1). FIG. 4 shows a person local universe or zone (402) within the transportation universe (1) as being in the contents space (9) of the transportation universe. The direct connections points by way of the markers (virtual or real) (303) are shown; while in the physical world the points are connected by soil, concrete, wood, and other materials as the physical world has no discontinuities. The direct connection points are at the markers while the lines, etc. connecting the points are defined between the markers (virtual or real) by the function Fn(xi,yi,zi,fi,ti . . . ).

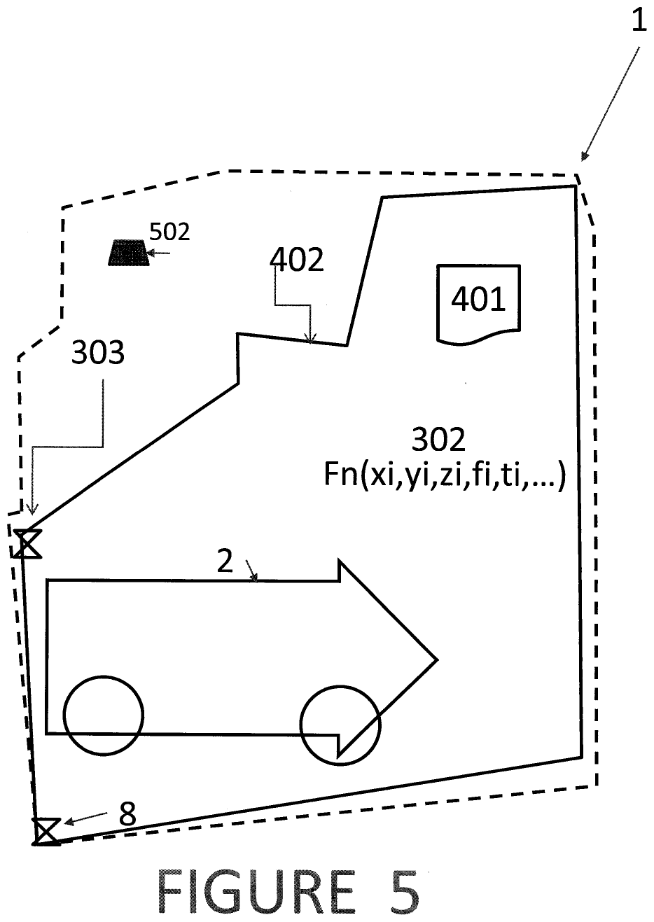

FIG. 5 is a diagrammatic view of the vehicle (2), in the zone (402) within the transportation universe (1), with direct connection points by way of the local/personal universe or zone markers (303) also shown, while in the physical world the points are connected by soil, concrete, wood, and other materials as the physical world has no discontinuities. A device (502) is shown which obtains data from other sources inside the transportation universe. The direct connection points are at the markers (virtual or real) (8) while the lines, etc. connecting the points are defined between the markers by functions Fn(xi,yi,zi,fi,ti . . . ) (302). A personal local universe definition device (401) can allow a human to define a local/personal universe or zone.

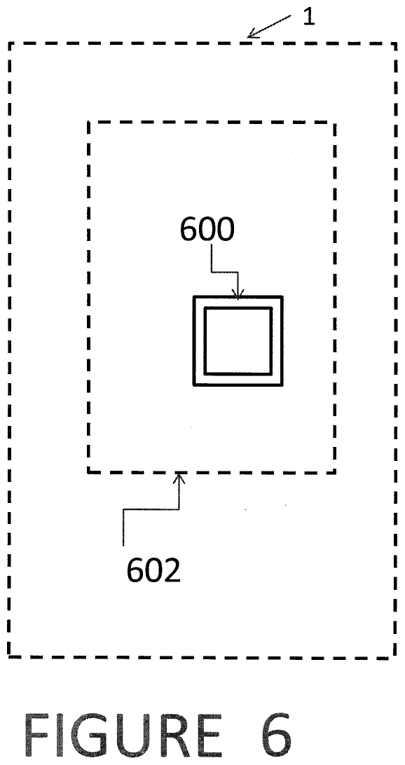

FIG. 6 shows the transportation universe (1) connected to owners, tenants, leases, private firms, government, etc. (600). Shown is an owner (600) who owns and controls all rights to a zone (602), the owner being a person, a business, a government, or other owner type. The owner controls all the lands, etc. via a direct ownership right and may erect barriers (real or virtual) to defines it control of its zone when in or out of the transportation universe. The personal/local universe or zone may and can include controls related to laws, policy, engineering limitations, design , risk, etc. but these are either integrated into the vehicle controls which the transportation universe solely and wholly controls, or the transportation universe will not incorporate or control those which are not integrated, so a zone within the zone may result. When the owner cedes full and functional control to the transportation universe, the transportation universe adds all the owner's information to the universe to define new boundaries, content, etc. and to control all vehicle movement in the added zone. The zone is aggregated with other zones (not shown) into the transportation universe (1). Once incorporated by the transportation universe all in zone vehicles and vehicle movements are controlled solely by the transportation universe.

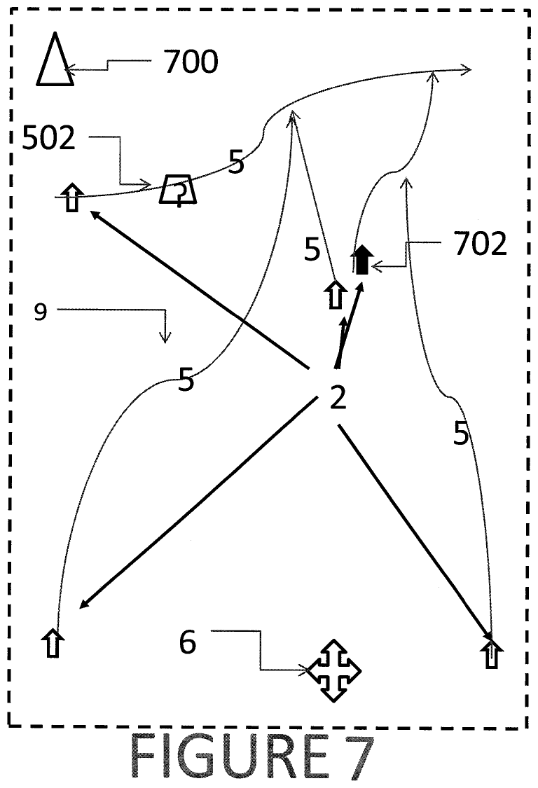

FIG. 7 shows universe controlled vehicles (2) and the transportation universe (1). An environmental/weather conditions station is shown (502). Vehicle (702) is part of an aggregated (virtual or real aggregation) fleet as it polls by questioning and investigation (502) for road surface conditions from external sources and by such activities as applying brakes, torques, LIDAR distancing, etc. to determine physical conditions and responses. The data is supplied to the central control (6) and control function Fn(xi,yi,zi,fi,ti . . . ) so all vehicles on the various paths (5) can be controlled solely and wholly by the transportation universe.

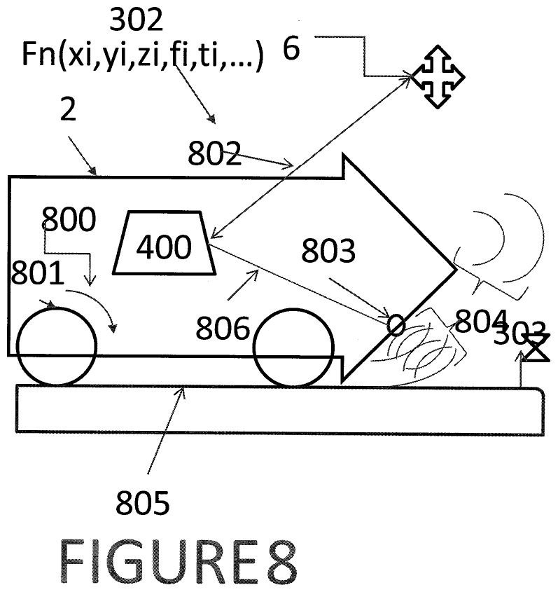

FIG. 8 is a vehicle (2) in the transportation universe on a road surface (805). A central control (6) is shown receiving and sending data from an onboard data device (400) via a signal train (802) that moves between the data device (400) and central control (6) for use of Fn(xi,yi,zi,fi,ti . . . ). A marker (303) is shown within sensor range in FIG. 8.

FIG. 8 shows the vehicle testing road conditions. A torque (800) is applied lightly at a wheel (801) in this case. A series of devices (LIDAR, infrared, friction wheel, moisture meter, thermometer, radio signal receiver, artificial eye, microphone, GPS signal receiver, energy receiver, time, accelerometer, air pressure meter, and so on (803) are shown. The devices receive various data signals (804). The data signals (804) are relayed back to the on board device on a transmission path (wireless, wired, mechanical) (806) and then communicated to the central control (6) using the data train (802).

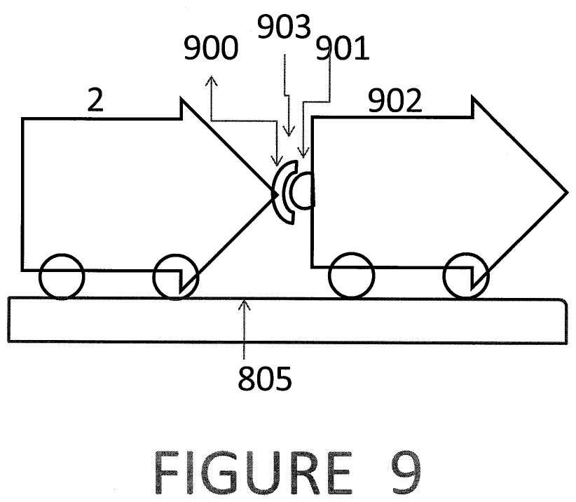

FIG. 9 shows a connection of in transportation universe vehicles (2, 902) that are travelling on a road surface (805). The connector may be real or virtual.

An interceptor connector (900) is shown on one vehicle (2) and an approach connector (901) is shown on another vehicle (902). Connectors are on all four walled surfaces of the vehicles. A connector may be a solid connection (mechanical, magnetic, chemical, glue, rasp, etc), an air gap, or virtual and is mediated by the central control which controls the vehicles (2, 902) while the functions Fn(xi,yi,zi,fi,ti . . . ) carries out the calculations in the central control.

The gap (903) between the connectors may have distance ranging from zero meters to infinity and the gap may be real or virtual.

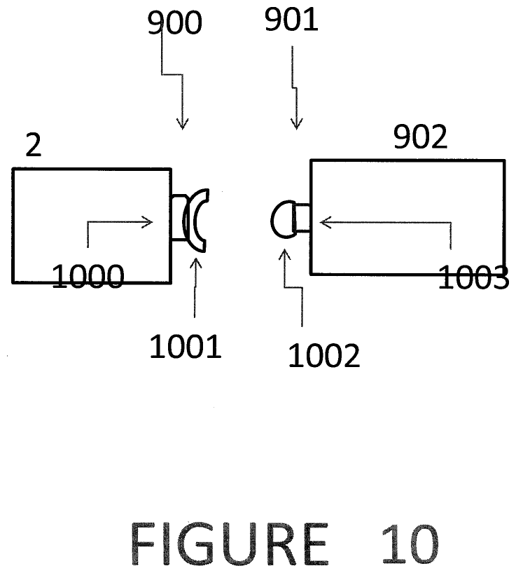

FIG. 10 shows the interceptor connector (900) and its basic components, the interceptor fitting (1001) which the transportation universe uses to mediate the positioning and the transition assistor (1000) to smoothens the interception and connects to a vehicle (2) so movements of both vehicles are fully controlled individually and jointly solely by the transportation universe. The transition assistor may be magnetic, electrical, hydraulic or may be virtual based on the central control using the function Fn(xi,yi,zi,fi,ti . . . ).

FIG. 10 shows the approach connector (901), the approach fitting (1002) and the approach assistor which the transportation universe uses to smoothen the interception and connects to a vehicle (902) for passenger comfort or integrity of goods.

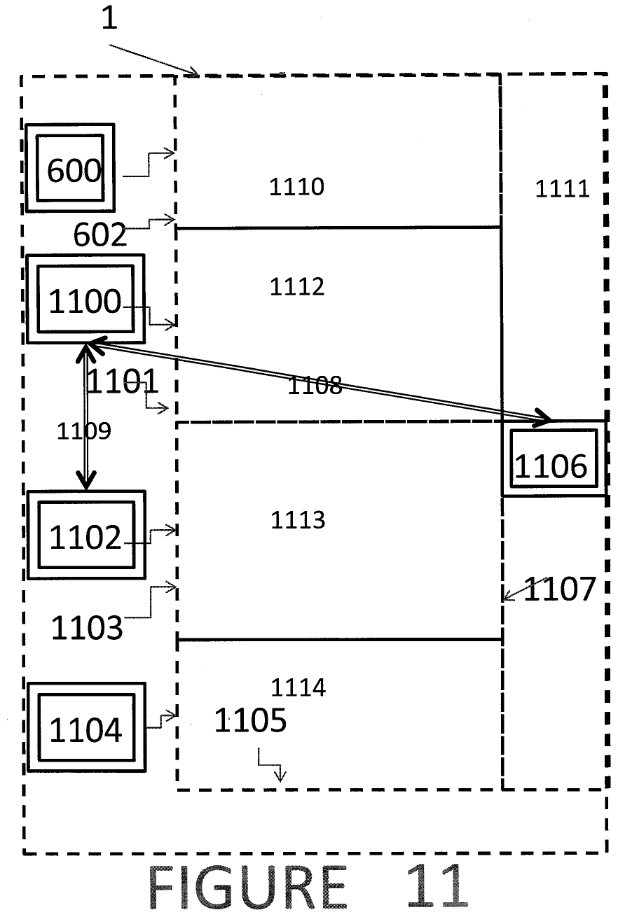

FIG. 11 shows the transportation universe (1) in relation to a number of typical owners (600, 1100, 1102, 1104, and 1106). The boundaries (virtual or real) of the various respective owner's local/personal universes or zone are shown in FIG. 11 (602, 1101, 1103, 1105, and 1107).

The content space of the zones are shown (1110,1112, 1113, 1114,1111).

Also show is a connection (virtual or real) (1108) between owners at 1100 and 1106, and a connection (virtual or real) (1109) of owners at 1100 and 1102.

Note from FIG. 11, that the transportation universe (1) encompasses all zones or local universes, but that the local universes or zones do not comprise all of the transportation universe nor do the zones necessarily communicate (for example a coffee shop might not communicate with a school on the “other side” of its local zone.

Note from FIG. 2 and FIG. 11 that as local/personal universes and zonea are added and removed from the transportation universe, that the universe and its' function Fn(xi,yi,zi,fi,ti . . . ) will change accordingly.

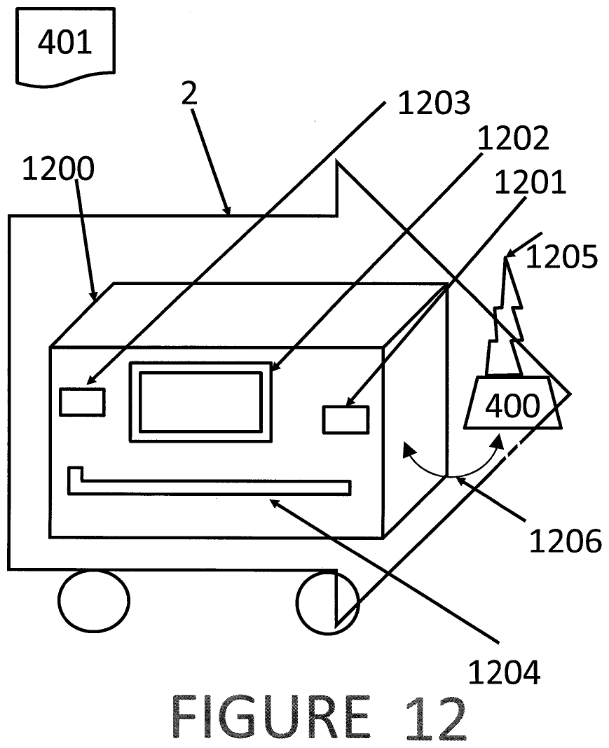

FIG. 12 shows a vehicle (2) of the transportation universe of FIGS. 1 and 2. Within the vehicle is an occupancy space (1200). Within the occupancy space, for the benefit and use of passengers are shown assorted equipment (1201, 1202, 1203, 1204) which are customizable managed equipment for use by an occupant.

FIG. 12 shows an attachable personal data device (400) which an occupant uses or the vehicle uses to send data and equipment data on a data train(1205) to the central control. The data connection informing the vehicle of the occupant equipment is shown (1206). A zone definition device (401) used by the owner of the vehicle is shown and may not be active at all times.

The personal data device (401) of FIG. 4 records, transmits, calculates loads, electrical needs, temperature, duration of use, internet, and similar services independent of the central control of the transportation universe, so that the integrity of the transportation system, the central control, the function Fn(xi,yi,zi,fi,ti . . . ), safety, vehicle movements can be assured and kept isolated from internal or external hijacking of trips or movements of vehicles so that transportation sole and whole control is not impacted.

The separation of the personal data device (401) also offers the occupant separation between destination decisions and space (1200) planning and use, so that the occupant can control use of space and time inside the controlled vehicle (2) for the occupant perceived optimal use.

In FIG. 12, the occupants makes custom changes, generally small during the trip or possibly larger at other times, which becomes communicated to the transportation universe, which can then adjust braking, steering, safety protocols, etc. in the central control by the function Fn(xi,yi,zi,fi,ti . . . ).

In FIG. 12, the transportation universe can be used to move vehicles (see FIGS. 1, 2, 5, 8, 9) carrying goods or equipment in the occupancy space (1200). A government, manufacturer, military logistics, etc. agency can then use the data function devices (400,401) to track, plan and design inventory, load progress, load or vehicle aggregation from origin to destination.

Further, the illustrated embodiment transportation system compromises a defined transportation universe (on earth) (1 FIG. 1) having content space (9 FIG. 1) and content (including vehicles (2 FIG. 1), zones (602 FIG. 6), markers (8 FIG. 1). Some elements of the transportation universe, say markers (8 FIG. 1) are real and some are virtual (speed limits). Markers and other elements can enter into the transportation universe for use in the movement and optimization calculation function (Fn(xi,yi,zi,fi,ti . . . ) as part of zones, as part of the universe itself, and could include insertable/removal (construction cones, etc) or permanent (buildings, etc.) contents and boundaries.

The central control system (6 various Figures including FIG. 1) is for controlling the transportation universe (1 various Figures including FIG. 1) and comprises a plurality of algorithms, AI, computers, quantum controllers and algorithms, servers interconnected one to the other in data communication relation. The central control system (6 FIG. 1) is programmed to develop a route plan (5 FIG. 1) for each vehicle and control each vehicle (2 FIG. 1) along its journey under control of the central control (6 FIG. 1) when in the transportation universe (1 FIG. 1) to thereby provide full control of traffic in the transportation universe (1 FIG. 1). In determining a route plan, the central control system (6 FIG. 1) not only considers the vehicles (2, FIG. 1) and the various possible routes, but also considers unplanned obstacles, including unplanned obstacles that suddenly appear and/or move, including bicycles, pedestrians, pedestrians with walkers, baby bunnies, construction, debris, laws, policy, other virtual information, and so on.

The plurality of vehicles comprises various types of vehicles capable of being moved through the transportation universe (1 FIG. 1) by the central control system (6 FIG. 1). Each vehicle has a vehicle identification unit that must be recognized by the central control system (6 FIG. 1) and the vehicle is connectable in two-way data communication with and full control by the central control system and is therefore a transportation universe capable vehicle (2 FIG. 1). Preferably, each vehicle (2 FIG. 1) is motor powered so as to be movable within the transportation universe (1 FIG. 1) under the control of the central control system (6). It is envisioned that it is possible to have a subsystem within the transportation universe (1 FIGS. 1 and 2) that itself moves non-motor-powered vehicles along (such as non-motorized bicycles, horse-drawn buggies, and so on); however, it is contemplated that this would most likely be uncommon. It should be understood that vehicles such as streetcars and subways, and the like, that typically derive their power from an external source, are still motor powered and can be fully controllable by an external computer system such as the central control system (6). Each vehicle (2 FIG. 1) in the transportation universe (1 FIG. 1) is controlled by the central computer system (AI, etc.) interacting with the identification unit in the vehicle. No vehicle in the transportation universe operates autonomously.

Some of the vehicles (2 FIGS. 1 and 2) are privately owned vehicles, such as privately owned cars and the like. Some of the vehicles (2 FIGS. 1 and 2) are corporately owned vehicles, such as rental cars, transport trucks and delivery trucks, and the like. Further, some of the vehicles (2 FIGS. 1 and 2) are publicly owned vehicles, such as buses, streetcars, subways, trains, and the like. It should also be understood that this transportation universe (1 FIG. 1) extends to vehicles that typically do not just travel on land, but also travel in the air and also on water.

Each of the vehicles (2 FIGS. 1 and 2) can enter into the transportation universe (1 FIG. 1) through the transportation universe boundary (9 FIG. 1) at one of a plurality of entry points and can exit from the transportation universe (1 FIG. 1) through the transportation universe boundary (9 FIG. 1) at one of a plurality of exit points, where the boundary may be a personal/local universe or zone (402 FIG. 4, 602 FIGS. 6 and 12). A user starts a journey at the origin point (3 FIG. 1) to the transportation universe (1 FIG. 1), or in other words the origin (3 Figure) of the trip, and ends a journey at the destination point (4 FIG. 4) to the transportation universe (1 FIG. 1).

The entry of each vehicle (2 FIG. 1) into the transportation universe (1 FIG. 1) is at the sole control of the central control system (6 FIG. 1). In the illustrated embodiment, the entry of each vehicle (2 FIG. 1) into the transportation universe (1 FIG. 1) is controlled by the central control system (6 FIG. 1) on a real time basis.

A user, or the user's cargo, or the like, enters the transportation universe (1 FIG. 1) prior to or subsequent to entering an controlled vehicle (2 various Figures including 12). Typically, the entry of each vehicle (2 various Figures including 12) into the transportation universe (1 various Figures including FIG. 1) is invoked by the user, and may be accomplished by the user engaging a destination entry device (FIG. 1). The destination entry device (7 FIG. 1) may be a computer system within the vehicle (2 various Figures including FIG. 12), or may be a portable communication device such as a cell phone, or tablet or portable computer, or may be a dedicated device. In a simplified form, the user could enter the transportation universe (1 various Figures including FIG. 1) by pressing a start button on a computer system in the vehicle (2 FIG. 1). Alternatively, a secure form of identification could be used, such as a password or the like, or biometrics (fingerprints, facial recognition, and so on), or an identification card or the like, or an electronic pass code from a portable communication device such as a cell phone, or tablet or portable computer, or a dedicated device.

Each of the plurality of vehicles that enters into and exits from the transportation universe boundary (9 FIG. 1) travels a journey between the entry point and the exit point. At least some, and typically all, journeys are at least partially pre-defined. In other words, when a vehicle (2 FIG. 1) enters the transportation universe (1 FIG. 1), the route of the journey is already preplanned and known or becomes dynamically replanned as more zones, vehicles, etc. are present. At least some journeys are fully pre-defined (e.g. subway trains).

Each vehicle (2 FIG. 1) is controlled along the journey at the same time as each other vehicle (2 FIG. 1) when in the transportation universe (1 FIG. 1) to thereby provide fully controlled vehicle movement in the transportation universe (1 FIG. 1). More specifically, each vehicle (2 FIG. 2) is controlled along the journey in co-operation with each other vehicle (2 FIG. 2) when in the transportation universe (1 FIG. 1) by way of automatically spacing each vehicle gaps (2 (FIGS. 1,9, 10), 903 FIG. 10)) from the others, and by way of automatically coupling together at least some of the vehicles together as the vehicles travel on their journeys. Other parameters may also be used to properly control the vehicles (2 FIGS. 7,8) along their journeys.

One of the main features of the present invention is that a portion of the vehicles (2 FIG. 2) on a journey in the transportation universe (1 FIG. 2) can be aggregate (real or virtual) relating to destination matters, safety matters, control, joint control, gap control by the central control system (6 FIG. 1) which uses the control function controls the travel of the group as one unit along at least a portion of their journeys, and even along the entirety of their journeys.

Typically, but not necessarily, each of the vehicles in the group of vehicles has a common destination one with the others from time to time. Also, or alternatively, the vehicles and a grouping may travel together for all or part of the journey. The number of vehicles in the grouping of vehicles changes during the journey. A vehicle (2 FIG. 1) can be requested by a user within the vehicle (2 FIG. 1), or by the central control system (6 FIGS. 1,2), to leave a group or change a destination at any time during the journey of the controlled vehicle (2, FIG. 2).

The transportation universe (1 various figures including FIG. 11), as illustrated, also includes streets and street intersections. The journey of a first group and the journey of the group that pass through a common intersection, such as a street intersection, are each timed to preclude physical interference of any vehicle with any other vehicle, or in other words, one group passes through the intersection first and the other passes through the intersection subsequently. It should be understood that the vehicles (2 FIG. 2) in a group may not be close together, and might even be substantially separated. For instance, they may be starting from separate destinations and travelling to a common destination at different times, but using a common route or uncommon portion of a route. Another scenario is that the vehicles (2 FIG. 2) in a group may be starting from a common starting point at different times and maybe traveling to the same or different destinations but share a common route for at least part of the journey. The present invention takes advantage of being able to plan a common route, or some common routes for these vehicles (2 FIG. 2) and control the vehicle (2 Various Figures including 2 and 12) similarly, thus allowing for safe coordinated control of vehicles (2 FIG. 2) within the transportation universe (1 various Figures including 1,2,3 11)).

Other variations of the above principles will be apparent to those who are knowledgeable in the field of the invention, and such variations are considered to be within the scope of the present invention. Further, other modifications and alterations may be used in the design and manufacture of the transportation system and method of the present invention, without departing from the spirit and scope of the accompanying claims.

FIG. 1 shows a Transportation Universe and a controlled vehicle within the Transportation Universe. FIG. 1 shows the Transportation Universe boundary (9), the controlled vehicle (2), an origin of a trip (3), a destination of a trip (4), a route plan (5), a central control (6), and a destination entry device (7).

Referring now to the invention in more detail, in FIG. 1 there is shown a Transportation Universe, that in the case of land transportation may be considered a fully controlled driving universe. The Transportation Universe comprises of private, proprietary and government owned right of ways/properties and may include parking areas, green space, driving areas, intersections, surfaces, stormwater control devices, toys, articles of clothing, smart markers such as QR codes, bar codes, bridges, underpasses, rail crossings, parking spaces, tools, construction equipment, building boundaries, fences, signs, databases, transmitters, receivers, boundaries, surveys, legal rights of ways, and so on. The Transportation Universe includes right of ways that are defined by legal metes and bounds, by engineering and other designs, so that the exact shape and configuration are known dynamically. The Transportation Universe can be added to or subtracted from as appropriate. The transportation universe (an intellectual and physical construct—i.e. not a galactic structure) is a controlled space in which only vehicles fully and solely controlled by the transportation universe may move as vehicles noting that persons, obstacles, animals, buildings, etc. are present which persons and obstacles are identified by at least one carried marker to the central control in the control function (Fn(xi,yi,zi,fi,ti . . . ).

The markers can be virtual or real (physical pins, decals, radio points, concrete markers, buildings, laws, policy, anything that the Transportation Universe can be identified by and can identify itself by, these are boundaries, either purposely placed or learned (that is physical or virtual). A place boundary marker could be a steel pin, a post with an RFID marker, a wall with a data containing decal. A city might buy 1000 or 20000 decal markers which can be read to the Transportation universe. Once the Transportation universe knows the markers, it can check for them, and in storms or if they are destroyed, the universe remembers the markers virtually and can act on them. Homeowners, school boards, business could put up real or virtual markers up for their own use, even temporarily to parking could be on a lawn or so parking cannot occur.

In FIG. 1 the central control (6) and all computation and data transmission must be secure.

The Collaborative Transportation Universe in FIG. 1 includes vehicle (2) so manufactured, vehicle (2) so modified, and other surface occupants as to be able to be controlled by the transportation universe alone. The Transportation Universe is a defined universe, where the space and its occupants are known.

The Transportation Universe in FIG. 1 also includes markers (8) which serve to define the physical dimensions and bounds of the system and which may include survey pins, radiative and acquisition data devices for information in such energy as sound, radio, visible light, heat, light, passive data devices such as signs, stripes, pavement conditions detected by in or extra universe devices, or direct connect communication devices for energy either passively or deliberately for such energy as sound, light, pressure, velocity, and contact pressure.

The Transportation Universe in FIG. 1 includes an origin (3) where the vehicle (2) starts it journey to a destination (4) along a path (5) being controlled by the central control (6). The central control (6) is a computer or computers acting collaboratively, communicating with vehicles, boundaries, markers, transmits and receives data, and assigns the path (5) to the destination (4). The central control then assigns and calculates trips, energy, lane use, spaces, direction, connection, and safety conditions to the vehicle, stops, starts, speeds, movements, loads, etc. to fully control all vehicle movements. The transportation universe might assign all lanes and space to a single direction for example to speed trip times for the path (5).

In FIG. 1, a human wanting to access a vehicle (2) from an origin (3) to a destination (4) uses a destination entry device (7). The device (7) which may include devices such as a data entry tablet, a destination data device plugged into an arrived or parked vehicle, a voice activated command tool, a smart phone or smart device, etc. or an electronic map tool showing a destination is either on board the vehicle (built in) or carried by the human to the vehicle. Whatever tool is used as the directed destination device, once the destination (4) is entered, the in universe vehicle is put under the full and sole control of the central control, and no further control over the vehicle is provided to the occupant except to alter the destination while the trip is underway on the path (5) using the destination entry device. Braking, acceleration, lane control, risk allocation, space allocation, lane use, etc. are outside the direct control of the occupant or pilot, and there is no pilot function allowed for until the universe gives up control. Once leaving the origin (3), if the human wants to specify a new destination (4), that can be accomplished using the destination entry device (7). The Transportation Universe (1) will be a controlled universe so that humans cannot inadvertently enter or exit the vehicle (2) in an unsafe location in the Transportation Universe, defined by markers (8).

In FIG. 1, the destination device may include alarms to set departure times, transmitted to a device that the person will receive so that a destination arrival time can be planned and priority assigned. Other vehicle controls such as light, heat, air, computers, tablets, entertainment tools, and work tools can integrate into the vehicle.

FIG. 2 shows the general operation of a Transportation Universe (1). Multiple vehicles (2) represents a plethora of vehicles being aggregated into a group (virtual or real) (203) from different origins (200) to different destinations (201) along multiple paths (5). The central control decides on such matters as vehicle speed, lane allocation, lane direction, intersection space allocation, connections, safety, universe conditions, boundary conditions, reliability of existing route data, marker information, safety, gaps, fuel use and new marker information to plan the trips along paths (5). The aggregated vehicles may be in close proximity or actually touching. Each vehicle was originally assigned a destination (201). The transportation universe assigned the path (5), speeds, groupings (203), gaps, etc..

In FIG. 3 the Transportation Universe (1), its boundaries (404) and the area/content space of the Transportation Universe (9) are shown. The markers (8) are known or become known to the central control (6). The function Fn(xi,yi,zi,fi,ti, . . . ) (302) from the markers is assembled and compiled for trip planning, lane planning, vehicle spacing, vehicle speed, destination planning, cross flows, safety, energy usage, vehicle movements, and other vehicle, destination, origin, passenger count, etc. to optimize the Fn(xi,yi,zi,fi,ti, . . . ) dynamically at all times.

In FIG. 3, the function Fn(xi,yi,zi,fi,ti, . . . ) (302) expands or contracts as needed. The markers, whether virtual or real, without limiting their location or data methods, may be bare ground, steel or metal boundary markers, on vehicles, posts, persons, on natural boundaries, trees, buildings, in clothing, tools, in boundary plans, in satellite data, in radio station transmissions, pavement markers and on articles carried and worn, and can include information from outside the TU such as aircraft or watercraft locations, the medium the vehicle is in (air, water, land, etc.) and portions of the function Fn(xi,yi,zi,fi,ti, . . . ) (302) may reside in memory or be shared with other parts of the Transportation Universe (1). In FIG. 3, a dynamic part of the memory Fn (xi,yi,zi,fi,ti, . . . ) (302) in the central control (6) remembers current vehicles and trips and past vehicles and trips as well as the associated paths. The data remaining in memory allows the Transportation Universe to learn and further optimize trips, to adapt to systemic or acute changes to the transportation system, destinations, vehicles or those entering upon or being impacted by the transportation system.

In FIG. 4 a transportation universe, with boundary (404) incorporates a zone (402) vehicle (2) which is equipped with an attached or attachable personal data device (400) and or other destination device. FIG. 4 shows a local/personal universe or zone definition device (401) used to define a local universe (402). The person in the vehicle can adjust the destination using the data entry device (400), but control remains with the transportation universe (1). Various boundary markers (local (303) in the zone, transportation universe (8)) are shown.

The local/personal universe or zone (402) has to be incorporated into the overall universe, whose boundaries are determined by the markers set by the person using the zone definition devices (401). The local universe will include contents such the vehicle, the surface, virtual or real boundaries or contents, etc. The contents are set within the context of the universe by the central control (6). If a car moves, the corner points move, if a driveway changes the markers move, etc.. The result of the use of the device (401) will be that real and virtual data on position, policy, translational needs, local pedestrians, local buildings, weight, and other matters can be geographically and parametrically transmitted or stored to the transportation universe (1) in the central control (6).

In FIG. 4 the zone definition device (401) must be secure, so that users may know their information is secure and not readily accessible or changeable. The user wants to be sure their universe and vehicle are secure and safe. By loading vehicle statistics, energy use, and the like onto their data devices, they can plan trips, maintenance, etc. The transportation universe will check for discontinuities, irregularities (e.g. road into water, boat into volcano or building).

In FIG. 4 the zone definition device (401) may be used to create a novel new personal/local universe or zone (402) for attachment to the Transportation Universe (1). The zone definition device can be used to describe new markers (300) and new function(s) Fn(xi,yi,zi,fi,ti . . . ) (302) by walking or physically moving the device from marker to marker, by entering data via a tablet, data entry device, smart phone, smart device, etc. by obtaining Fn(xi,yi,zi,fi,ti . . . ) (302) from other sources. The zone definition device (401) can allow a human to add a driveway, a parking space, a safe transport pathway, a hazard, a pot holes, etc. to the Transportation Universe and to set conditions. The zone definition device (401) may store the data for temporary use of the Transportation Universe (1) or the central control or it may add the information more permanently.

FIG. 4 shows the zone (402) is connectable to the Transportation Universe (1), that the zone is fully within the boundaries (404) of the transportation universe, and that the device (401) informs the data and trip device and the Transportation Universe via a central control (6).

FIG. 4 shows the zone definition device (401) which can be used by law enforcement, by contractors, by engineers, by public utilities, designers, to make permanent or temporary changes that result in personal/local universes or zones (402) which allow the Transportation Universe (1) to “understand and implement changes” so the changes become known throughout the Transportation Universe (FIG. 1) so that path planning can proceed as shown in FIG. 2.

In FIG. 5 the zone definition is added to the transportation universe (1). The zone definition device (401) can be used to describe new markers (303,8) and new function(s) Fn(xi,yi,zi,fi,ti . . . ) (302) by walking or physically moving the device from marker to marker, by entering data via a tablet, data entry device, smart phone or smart device, etc. by obtaining function(s) Fn(xi,yi,zi,fi,ti . . . ) (302) from other sources. The personal/local universe or zone definition device (401) is used for each zone/local/personal universe to add these to the transportation universe at the sole discretion of the transportation universe. A zone definition device (401) can allow a human to add a driveway, a parking space, a safe transport pathway, etc. to the transportation universe and to set conditions. The device (401) may store the data for temporary use of the transportation universe (1) or central control or it may add the information more permanently. FIG. 5 shows the zone (402) is connectable to the transportation universe (1) and that the device (401) informs the transportation universe (1) to the central control (6). The connections become markers (real or virtual) (303,8) which the transportation universe can use vehicle devices (e.g. 803, FIG. 8, r in universe devices (502) to poll for, or methods to detect.

Where the vehicle (FIG. 1, 2) and the Transportation Universe (FIG. 1, 1) finds boundaries, static and dynamic data, etc. used for defining trips seem to involve discrepancies (501) where the marker is outside the universe (but it could involve duplicate data), it can take several courses of action.

The first could include: selecting new paths (see FIG. 2), dispatch to the discrepancy with a zone device to assist in defining the markers (FIG. 4).

FIG. 6 shows the Transportation Universe (1) connected to owners and regulators (600). Shown is an owner (600) who owns and control all rights to a zone (602), the owner being a person, a business, a government, or other owner type. The owner controls all the lands via direct ownership right, and may erect barriers (physical, legal, social) to define its controls its portion of the Transportation Universe. When the owner cedes functional control, the Transportation Universe adds all information to define new boundaries. While zone (402) devices can and will be used (see FIGS. 4 and 5), the owner controls include legislated limits, design practices, control, enforcement, risk reduction, crisis intervention, and the like. When these are added to the Transportation Universe, and all owners are added either by design or route interrogation, an aggregated Transportation Universe can be defined and used.

FIG. 7 shows Vehicles (3) and the Transportation Universe (1). Path decisions are made based on the directed destination and path parameters. A Vehicle (702) can be used to poll road conditions. A pavement condition system (temperature, moisture, etc.) can further interrogate and inform the Transportation Universe. A weather station or network (700) collects environmental conditions station. FIG. 7 shows a vehicle (702) part of an aggregated fleet as it polls by questioning and investigation for road surface conditions from external sources and by such activities as applying brakes, torques, LIDAR distancing, etc. to determine physical conditions and responses. The data from the various devices and tools (700, 701, and 702) and other data polling are supplied to the central control (6) and other vehicles on the various paths (5).

FIG. 8 shows a vehicle (2) on a road surface (805). A transportation device (6) is shown receiving and sending data from an onboard data device value or data device (400). The devices that can be used can measure multiple data types, which includes road conditions, engine conditions, torque being applied, wheel pressures, road smoothness, distance to objects, heat of surfaces, electromagnetic radiation profile of objects, sounds, abrasion, dusts, etc. A torque (800) is applied lightly at a wheel (801). A series of devices (LIDAR, Infrared, friction wheel, moisture meter, thermometer, radio signal receiver, artificial eye, microphone, GPS signal receiver, energy receiver, time, accelerometer, air pressure meter, and so on (803) are shown.

In FIG. 8 shows a signal train moves data from the devices such as (700,701,702) between the data device (400) and allocation device (6) with the function data (302). A marker (303) is shown within sensor range in FIG. 8.

FIG. 8 shows a vehicle (2) testing road conditions. The various devices receive various data signals (804). The data signals (804) are relayed back to the data device on a transmission path (wireless, wired, mechanical) (806). Each vehicle will have appropriate sensor or data deriving device (700, 701, and 702, etc.) The device (701) is a device that polls for information in the transportation universe (1), while the device (702) is the vehicle which has a polling device on it (eg. Thermometer, moisture meter).

FIG. 9 shows a connection of vehicles (2, 902) that are travelling on a road surface (805). The connection may be by physical separable contact so there are no force induced connections or by means of contact only.

An interceptor connector (900) is shown on one vehicle (2). The connector (900) is shaped or made to accept connection in essentially one direction. The connection may be by contact or by proximity, as may be useful.

An approach connector (901) is shown on another vehicle (902). As vehicle (2) approaches vehicle (902), the adapter is monitored and adjusted. Depending on contact type the vehicle may move in complete collaboration or by a statistically driven separation. The advantage of physical contact can include less use of space, less use of fuel, increased safety, and support of a vehicle that suddenly loses power, and so on. The connecting gap (903) is between the interceptor (900) and the approach (901).

In FIG. 9, connectors may be on all four walled exterior vertical surfaces of the vehicles. A connector may be a solid connection (mechanical, magnetic, chemical, glue, rasp, etc.) or an air gap mediated by the vehicles (2, 902), the functions (302), and the trip allocation device (6).

Gap (903) mediated vehicle groups will tend to form when road traffic is sparse or intermittent.

In inclement weather solid connection (903) mediated vehicles will allow for increased stability against wind, rain, ice, fog and the like.

FIG. 10 shows the interceptor connector (900) and it basic components, the interceptor fitting (1001). To reduce the stress on vehicle 2 and occupants, any solid connections must be mediated to reduce impact loads and accelerations. The mediator 1000 may include magnetic cushions, springs, hydraulics, or replaceable impact absorbing materials. By mediating the positioning and the transition assistor (1000) reduces the sense of vehicle connection to occupants. Smoother the interception and connects to a vehicle (2) will improve safety.

FIG. 10 shows the approach connector (901) and the approach fitting (1002). To reduce the stress on vehicle 902 and occupants, any solid connections must be mediated to reduce impact loads and accelerations. The mediator 1003 may include magnetic cushions, springs, hydraulics, or replaceable impact absorbing materials. By mediating the positioning and the transition assistor (1002) reduces the sense of vehicle connection to occupants. Smoother the interception and connects to a vehicle (902) will improve safety.

FIG. 11 shows a Transportation Universe (1) in relation to a number of typical owners (600, 1100, 1102, 1104, and 1106) and their local universes (1110,1111,1112,1113,1114,1115 and so on). Each owner, either by engineering means determines the local boundaries and conditions or by means of the zone tool (FIG. 4, 401).

The boundaries of the various owners' jurisdictions are shown in FIG. 11 (601, 1101, 1103, 1105, and 1107). The total Transportation Universe will change as the jurisdictions change markers, as the director tool and related computers adapt to new data and paths (5) in FIG. 2.

FIG. 12 shows a Collaborative Destination Directed Vehicle (2) within the transportation universe (1) of FIG. 3. Within the Collaborative Destination Directed vehicle is an occupancy space (1200). Within the occupancy space, for the benefit and use of passengers are shown assorted equipment (1201, 1202, 1203, 1204) customizable managed equipment of self-owned/leased/rented/borrowed vehicles and standard for unowned Collaborative Destination Directed Vehicles (2). The equipment (1201, 1202, 1203, 1204 and the like) make occupancy space suitable for the comfort and use of the occupant.

FIG. 12 shows is an attachable personal data and trip device (400). The personal data and trip device records any equipment and customizable equipment and uses of equipment for the occupants and stores it for use and mediates data (1205) to the outside universe. Equipment data is sent via a connection to the personal data and trip device of FIG. 4.

The occupant can take the personal data and trip device for use in other vehicles or for later use, or can leave it in the vehicle.

The personal data and trip device (400) of FIG. 4 calculates electrical loads, weights, temperatures, speeds, duration of use, directs power requirements, and provides a data connection for internet and similar services to the outside for the benefit of the occupant of the occupancy space via Collaborative Transportation Trip Allocation device (6) of FIG. 1. Nevertheless, the occupant and occupant space uses, are and remain independent of the planning of the Transportation Universe, the Vehicle and the Collaborative Transportation Trip Allocation Device of FIG. 1. The separation is maintained to prevent internal hijacking or external hijacking of the trips, the safety features of the Transportation Universe and the Vehicles following the paths from origins to destinations as shown in FIG. 2.

Any changes to the destination of the vehicle are mediated by the occupant control pad, while local universes such as shown in FIGS. 5, 6 and 11 (1110,1111,1112,1113,1114,1115) which attach to the Transportation Universe and other Collaborative Destination Directed Vehicles (See FIG. 2 (3)). The separation of the occupancy and the destination planning allows for occupants to use the space as deemed appropriate by them, while allowing the Transportation Universe and vehicles to optimize comfort while maintaining safe control over the environment.

In FIG. 12, the occupant, when owning the equipment, merely changes the equipment, comfort, and like equipment and settings. The Collaborative Destination Directed vehicle senses weights, resistances, fuel use, maintenance issues via the Personal Data device. The Personal Data Key informs the occupant of loads that are handled, of user issues constrained by the resources of the vehicle, and the like so that resource allocation may be determined by the Collaborative Destination Directed Vehicle.

The various equipment (1201, 1202, 1203) can be computers, telephones, food devices, beds, chairs, logic gates, mechanical or pneumatic, toys, goods, and so on.

In FIG. 12, the Transportation Universe and Collaborative Destination Directed Vehicles (of FIG. 1) can the transport goods or the other equipment in the occupancy space. A manufacturing firm, a delivery firm, a government or military agency, could thus keep an inventory of the goods being moved and their location within the Transportation Universe while following the paths and aggregations of FIG. 2 from origin to destination. Loading and off-loading can be planned.

Further, the illustrated embodiment transportation system (10) comprises a defined transportation universe (1) having defined contents and a defined transportation universe boundary (9) that is defined by markers (8). At least some of the markers (8) are real, such as posts, road markers, and so on. Also, at least some of the markers (8) are virtual, or in other words, can be co-ordinates in the database of the central control system (6). Further, at least some of the markers (8) are pre-defined, such as posts, street corners, parking lot boundaries, and so on, while at least some of the markers (8) are insertable and removable, such as cones, special signs, electronic markers, and so on, and also various types of virtual markers enterable into the system via a computer, cell phone, or the like. At least some of the insertable and removable markers are insertable and removable by users. A user defines a start or origin location with respect to one or more of the markers (8).

The central control system (6) is for controlling the transportation universe (1) and comprises a plurality of servers interconnected one to the other in data communication relation. The central control system (6) is programmed to develop a route plan (5) for each vehicle and control each vehicle (2) along its journey in co-operation with each other vehicle (2) when in the transportation universe (1) to thereby provide fully control of traffic in the transportation universe (1). In determining a route plan, the central control system (6) not only considers the vehicles (2) and the various possible routes, but also considers unplanned obstacles, including unplanned obstacles that suddenly appear and/or move, including bicycles, pedestrians, pedestrians with walkers, baby bunnies, construction, debris, and so on.

The plurality of vehicles comprises various types of vehicles capable of being moved through the transportation universe (1) by the central control system (6). Each vehicle has a vehicle identification unit used by the central control system (6) and is connectable in two-way data communication with the central control system (6) and is therefore a controlled vehicle (2). Preferably, each vehicle (2) is motor powered so as to be movable within the transportation universe (1) under the control of the central control system (6). It is envisioned that it is possible to have a subsystem within the transportation universe (1) that itself moves non-motor-powered vehicles along (such as non-motorized bicycles, horse-drawn buggies, and so on); however, it is contemplated that this would most likely be uncommon. It should be understood that vehicles such as streetcars and subways, and the like, that typically derive their power from an external source, are still motor powered and fully controllable by an external computer system such as the central control system (6).

Each vehicle (2) in the transportation universe (1) is controlled by the central computer system interacting with the identification unit in the vehicle. No vehicle (2) in the transportation universe (1) operates autonomously.

Some of the vehicles (2) are privately owned vehicles, such as privately owned cars and the like. Some of the vehicles (2) are corporately owned vehicles, such as rental cars, transport trucks and delivery trucks, and the like. Further, some of the vehicles (2) are publicly owned vehicles, such as buses, streetcars, subways, trains, and the like. It should also be understood that this transportation system (10) extends to vehicles that typically do not just travel on land, but also travel in the air and also on water.

Each of the vehicles (2) can enter into the transportation universe (1) through the transportation universe boundary (9) at one of a plurality of entry points and can exit from the transportation universe (1) through the transportation universe boundary (9) at one of a plurality of exit points. A user starts a journey at the entry point to the transportation universe (1), or in other words the origin (3) of the trip, and ends a journey at the exit point to the transportation universe (1), or in other words the destination (4) of the trip.

The entry of each vehicle (2) into the transportation universe (1) is controlled by the central control system (6). In the illustrated embodiment, the entry of each vehicle (2) into the transportation universe (1) is controlled by the central control system (6) on a real time basis.

A user, or the user's cargo, or the like, enters the transportation universe (1) subsequent to or prior to entering a controlled vehicle (2). Typically, the entry of each vehicle (2) into the transportation universe (1) is invoked by the user, and may be accomplished by the user engaging a destination entry device (7). The destination entry device (7) may be a computer system within the vehicle (2), or may be a portable communication device such as a cell phone, or tablet or portable computer, or may be a dedicated device. In a simplified form, the user could enter the transportation universe (1) by pressing a start button on a computer system in the vehicle (2). Alternatively, a secure form of identification could be used, such as a password or the like, or biometrics (fingerprints, facial recognition, and so on), or an identification card or the like, or an electronic pass code from a portable communication device such as a cell phone, or tablet or portable computer, or a dedicated device.

Each of the plurality of vehicles that enters into and exits from the transportation universe boundary (9) travels a journey between the entry point and the exit point. At least some, and typically all, journeys are at least partially pre-defined. In other words, when a vehicle (2) enters the transportation universe (1), the route of the journey is already preplanned and known. At least some journeys are fully pre-defined.

Each vehicle (2) is controlled along the journey in co-operation with each other vehicle (2) when in the transportation universe (1) to thereby provide fully control of traffic in the transportation universe (1). More specifically, each vehicle (2) is controlled along the journey in co-operation with each other vehicle (2) when in the transportation universe (1) by way of automatically spacing each vehicle (2) from the others, and by way of automatically coupling together at least some of the vehicles together as the vehicles travel on their journeys. Other parameters may also be used to properly control the vehicles (2) along their journeys.

One of the main features of the present invention is that a portion of the vehicles (2) on a journey in the transportation universe (1) can be aggregated virtually or in reality to a common goal (least energy, least ghg, least time, safety, etc.) and are the a cohort of vehicles and the central control system (6) controls the travel of the cohort as one unit along at least a portion of the cohort journeys, and even along the entirety of their journeys. Cohorts may change during any trip.

Typically, but not necessarily, each of the vehicles in the cohort of vehicles has a common destination one with the others, but only that part of the journeys overlap. Also, or alternatively, the vehicles and a cohort may travel together for all or part of the journey. The number of vehicles in the cohort of vehicles changes during the journey. A vehicle (2) can be requested or commanded by a user within the vehicle (2) or by the central control system (6), to leave a a group or planned trip at any time during the journey of the vehicle (2) but the leaving will only be done under the sole and total control of the transportation universe for safety and other reasons.

The transportation universe (1), as illustrated, also includes streets and street intersections. The journey of cohort of vehicles through an intersection is controlled by the transportation universe using the central control and planning function Fn(xi,yi,zi,fi,ti . . . ) so that a second cohort can pass through a common intersection, such as a street intersection, are each timed to preclude physical interference of any vehicles from either cohort, saving time, energy, and money. It should be understood that the vehicles (2) in a cohort may not be close together, and might even be substantially separated. For instance, they may be starting from separate destinations and travelling to a common destination at different times, but using a common route or uncommon portion of a route. Another scenario is that the vehicles (2) in a group may be starting from a common starting point at different times and maybe traveling to the same or different destinations but share a common route for at least part of the journey. The present invention takes advantage of being able to plan a common route, or some common routes for these overlapping paths (5) of vehicles (2) and taking advantage of the control of the vehicle (2) similarly, thus allowing for safe coordinated control of vehicles (2) within the transportation universe (1).

The transportation system (10) further comprises personal identification units used by the central control system (6) and connected in two-way data communication with the central control system (6), for carrying by individuals entering the transportation universe (1) without a vehicle. The personal identification units may include a portable data communication device, a physical sensor, a visually readable code, or the like and so on.

The transportation system (10) further comprises a destination data device connectable in two-way data communication with the central control system (6). As illustrated, the destination data device comprises a data communication device installed in one the vehicles (2). The destination data device stores data regarding at least one destination, and typically stores data regarding various destinations of the user, and can be used in various vehicles (2). The destination data device preferably comprises a portable data communication device, such as a cell phone or tablet, or the like.

The transportation system (10) also further comprises sensors for monitoring the transportation universe (1) and connected to the central control system (6) for detecting unauthorized objects in the transportation universe (1) and providing an object alert to the central control system (6) regarding detected objects. The central control system (6) uses the object alert to the routes of groups or changes to routes of groups.

It is possible for the central control system (6) to redefine the transportation universe boundary (9) to accommodate the entry point of a user to the transportation universe (1). For instance, the transportation universe (1) might add a new registered user and the coordinates of the new registered users driveway would be entered into the central system, either via computer data entry or physical markers (8) placed at the driveway. Also, a registered user of the transportation system (10) that might change a home address or business address, or might add a driveway to a current home address or add a parking lot to a current business address.

The transportation universe (1) further comprises a route evaluation system for evaluating the effectiveness of travelled routes of journeys and producing a route evaluation for various journeys, and comparing various evaluations to develop route optimization data. The route evaluation system is part of the central control system (6) and helps with the optimization of route planning based on historical data.

The central control system (6) can allocate and reallocate the purpose of a predefined pathway, such as a street, in the transportation universe (1). This allocation and reallocation can be done dynamically, or in other words “on-the-fly”, or can be done on a periodic basis.

The central control system (6) can also gather environmental data, such as temperature, weather conditions, road conditions, and so on from at least some of the vehicles (2), and can use the environmental data to determine the route of an vehicle (2) or groups of vehicles.

One other important concept of the transportation system (10) according to the present invention is that the central control system (6) can preset or dynamically change the travel speed of vehicles on a predefined pathway and allow the entry of vehicles according to the amount of traffic the predefined pathway and another that the central control system can respond to crisis or changes in the transportation universe dynamically to other pathways and speeds. For instance, on a major highway where the speed limit might be 100 km/h, central control system (6) might control the vehicle (2) such that the vehicles (2) travel at 100 km/h, or maybe 90 km/h, even in times of high traffic. This would allow maximum throughput of traffic along the highway, although there might be some delay in getting onto the highway. This is in stark contrast to having traffic over congested on a highway and traveling at perhaps 10 km/h, or even temporarily stopped, thereby not using the highway to its fullest. This would be hugely advantageous in areas that experience severe traffic jams, such as during “rush hour”.

In another aspect, in the illustrated embodiment, the present invention comprises a transportation method comprising the steps of defining a transportation universe (1) including contents thereof and a defined transportation universe boundary (9); programming a central control system (6) to control the transportation universe (1); providing a plurality of vehicles with a vehicle identification unit controlled by the central control system (6) and connectable in two-way data communication with the central control system (6), such that the vehicles become connected vehicles (2), wherein each connected vehicle (2) is motor powered so as to be movable within the transportation universe (1) under the control of the central control system (6); controlling each vehicle (2) in the transportation universe (1) using the central computer system; permitting each of the vehicles (2) to enter into the transportation universe (1) through the transportation universe boundary (9) at one of a plurality of entry points and to exit from the transportation universe (1) through the transportation universe boundary (9) at one of a plurality of exit points; wherein each of the plurality of vehicles that enters into and exits from the transportation universe boundary (9) travels a journey between the entry point and the exit point; controlling each of the vehicles (2) along the journey in co-operation with each other vehicle (2) when in the transportation universe (1) to thereby provide fully control of traffic in the transportation universe (1); for a predefined pathway, maintaining the speed of each vehicle (2) on the predefined pathway at a predetermined minimum speed to thereby maximize the amount of traffic flow on that predefined path; and for a predefined path, allocating and reallocating the purpose of a predefined pathway in the transportation universe (1).

In another aspect, in the illustrated embodiment, the present invention comprises a computer system comprising one or more servers programmed to communicate with a plurality of vehicles over a communication link for effecting fully control of traffic in a transportation universe (1), the one or more servers comprising at least one data processor configured to define a transportation universe (1) including contents thereof and a defined transportation universe boundary (9); control the transportation universe (1) via a central control system (6); authorize a plurality of vehicles with having a vehicle identification unit and connectable in two-way data communication with the central control system (6), such that the vehicles become vehicles (2), wherein each vehicle (2) is motor powered so as to be movable within the transportation universe (1) under the control of the central control system (6); control each vehicle (2) in the transportation universe (1) using the central computer system; permit each of the vehicles (2) to enter into the transportation universe (1) through the transportation universe boundary (9) at one of a plurality of entry points and to exit from the transportation universe (1) through the transportation universe boundary (9) at one of a plurality of exit points; wherein each of the plurality of vehicles that enters into and exits from the transportation universe boundary (9) travels a journey between the entry point and the exit point; control each vehicle along the journey in co-operation with each other vehicle (2) when in the transportation universe (1) to thereby provide fully control of traffic in the transportation universe (1); maintain the speed of each vehicle (2) along its journey on a predefined pathway at a predetermined minimum speed to thereby maximize the amount of traffic flow on that predefined path; and allocate and reallocate the purpose of a predefined pathway in the transportation universe (1).

As can be understood from the above description and from the accompanying drawings, the present invention provides a transportation universe with vehicles and users within it unitary in nature, provide a transportation universe and vehicles, to provide a transportation system and method wherein each vehicle is controlled along said journey in co-operation with each other vehicle when in the transportation universe to thereby provide full control of traffic in the transportation universe, to provide a transportation system and method wherein for a predefined path, each vehicle on the predefined pathway is maintained at a predetermined minimum speed to thereby maximize the amount of traffic flow on that predefined path, to provide a transportation system and method wherein the central control system can allocate and reallocate the purpose of a predefined pathway in the transportation universe, to provide a transportation system and method that is not a system of avoidance and competition, to provide a transportation system and method transportation system wherein travelled pathways are well used in terms of minimizing gaps, bi-directional of pathways, multidirectional lanes, and efficient intersections, to provide a transportation system and method transportation system wherein humans and autonomous systems are not used to pilot vehicles, to provide a transportation system and method transportation system that is a non-chaotic transportation system, to provide a transportation system and method transportation system wherein other vehicles and obstacles and humans are not treated as antagonistic to the optimal route to a destination and to the pilot and to other occupant safety, to provide a transportation system and method transportation system that minimizes injury, death, loss, lost time, wasted energy and wasted greenhouse gas expenditures, to provide a transportation system and method transportation system without subversive impaired and distracted drivers, to provide a transportation system and method transportation system without inexperienced vehicle operators (pilots) and vehicle operators (pilots) with diminishing capacity.

Other variations of the above principles will be apparent to those who are knowledgeable in the field of the invention, and such variations are considered to be within the scope of the present invention. Further, other modifications and alterations may be used in the design and manufacture of the transportation system and method of the present invention, without departing from the spirit and scope of the accompanying claims.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising”, “having”, “including”, and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g.,“such as”, “for example”) provided herein, is intended merely to better illuminate embodiments of the invention and does not pose a limitation on the scope of the invention unless otherwise claimed. No language in the specification should be construed as indicating any non-claimed element as essential to the practice of the invention.

Another aspect of transportation method is that it comprises the steps of:
defining a transportation universe including contents thereof and a defined transportation universe boundary;
programming a central control system to control the transportation universe;
providing a plurality of vehicles with a vehicle identification unit used by said central control system and connectable in two-way data communication with said central control system, such that said vehicles become controlled vehicles, wherein each vehicle is motor powered so as to be self-movable within the transportation universe under the control of said central control system;
controlling each vehicle in the transportation universe using said central computer system;
permitting each of said vehicles to enter into the transportation universe through the transportation universe boundary at one of a plurality of entry points and to exit from the transportation universe through the transportation universe boundary at one of a plurality of exit points;
wherein each of said plurality of vehicles that enters into and exits from the transportation universe boundary travels a journey between said entry point and said exit point; and,
for a predefined pathway, maintaining the speed of each vehicle on said predefined pathway at a predetermined minimum speed to thereby maximize the amount of traffic flow on that predefined path.

Another aspect of the invention is that it is a transportation system comprising:
a defined transportation universe having defined contents and a defined transportation universe boundary;
a central control system for controlling the transportation universe;
a plurality of vehicles having a vehicle identification unit for use by said central control system and connectable in two-way data communication with said central control system and is therefore a fully and wholly universe controlled vehicle;
wherein each vehicle in the transportation universe is controlled by said central computer system interacting with the identification unit in said vehicle;
wherein each vehicle is motor powered so as to be movable within the transportation universe under the control of said central control system;
wherein each of said vehicles can enter into the transportation universe through the transportation universe boundary at one of a plurality of entry points and can exit from the transportation universe through the transportation universe boundary at one of a plurality of exit points;
wherein the entry of each said vehicle into the transportation universe is controlled by said central control system;
wherein each of said plurality of vehicles that enters into and exits from the transportation universe boundary travels a journey between said entry point and said exit point; and,
wherein said central control system can allocate and reallocate the purpose of a predefined pathway in the transportation universe.

Another aspect of the invention is that it as transportation method comprising the steps of:
defining a transportation universe including contents thereof and a defined transportation universe boundary;
programming a central control system to control the transportation universe;
providing a plurality of vehicles with a vehicle identification unit for use by said central control system and connectable in two-way data communication with said central control system, such that said vehicles are motor powered so as to be movable within the transportation universe under the sole and whole control of said central control system;
controlling each vehicle in the transportation universe using said central computer system;
permitting each of said vehicles to enter into the transportation universe through the transportation universe boundary at one of a plurality of entry points and to exit from the transportation universe through the transportation universe boundary at one of a plurality of exit points;
wherein each of said plurality of vehicles that enters into and exits from the transportation universe boundary travels a journey between said entry point and said exit point; and,
for a predefined path, allocating and reallocating the purpose of a predefined pathway in the transportation universe.

A transportation system universe equipped to detect pedestrians, animals, weather conditions, or objects to protect the pedestrians and animals and to protect the vehicle occupants and contents from damage due to pedestrians, animals, objects, and weather.

Illustrated embodiments of this invention are described herein. Variations of those illustrated embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Further, nothing in the above-provided discussions of the transportation system and method should be construed as limiting the invention to a particular embodiment or combination of embodiments. The scope of the invention is defined by the appended claims.

1. A transportation system comprising:
a. a transportation universe in one or all of air, land, water wherein all vehicle movements are controlled using a controlling function Fn(xi,yi,zi,fi,ti, . . . ) implemented by and in a central control system such that the transportation universe
b. contents and boundaries that are physical,
c. contents and boundaries that are intellectual constructs such as laws, and
d. contents and boundaries are real (cars, fences, etc) or intellectual constructs (laws, policy, etc.) and are identified into the universe by sensors, direct data input, engineering designs, etc. as mathematical formulations using the central control and the controlling function Fn(xi,yi,zi,fi,ti, . . . ).

2. The transportation system according to claim 1 further including: the controlling function Fn(xi,yi,zi,fi,ti, . . . ) including variables and calculations which encompass intellectual constructs and physical real world elements into mathematical model representations of: engineering principles, scientific principles, laws, locations, social, environmental, policy, priorities, using the model representations in calculations for decision making to control all movements of all vehicles in the transportation universe.

3. The transportation system according to claim 1 further including: the controlling function Fn(xi,yi,zi,fi,ti, . . . ) including:
a. using data from in or out of universe devices and sources to plan and control all movements of all vehicles in the entire transportation universe.
b. using dynamically changing models, data, inputs, to plan and control all movements of all vehicles in the entire transportation universe.
c. employing a central control and computer to communicate and receive all movement directions and information to and from all in vehicle movement control devices and to solely and totally control and adjust the movement control devices to control all movements in the transportation universe.

4. The transportation system according to claim 1 further including: The central control using the controlling function Fn(xi,yi,zi,fi,ti, . . . ) to:
a. Receive or send data from inter and extra universe sources (devices) comprising of real (equipment) or and intellectual constructs (laws, etc.)
b. make planning decisions and control functions.
c. receive data from inter and extra universe sources (devices) comprising of real (equipment) or and intellectual constructs (laws, etc.) to define boundaries (real or intellectual constructs (e.g. speed limits)) or contents (real or intellectual constructs (e.g. conservation law)).

5. The transportation system according to claim 1 further including: The transportation universe where only the universe at its' sole and total discretion and control of the universe can adjust vehicle movements of all zones connected:
a. Such that vehicle gaps, road direction, are controlled by the central control using the controlling function Fn(xi,yi,zi,fi,ti, . . . ) by acting on devices in the vehicles,
b. Such that safety, fuel and resource use, gaps, time use is optimized by the central control using the controlling function Fn(xi,yi,zi,fi,ti, . . . ) and no human or other pilot can alter movement of the vehicle directly,
c. In response to a human who may enter a change of desired outcome using an in or extra universe device to communicate to the central control but at all times all vehicle movement and vehicle decisions remain solely and totally with the transportation universe until control can be safely given up,
d. by control devices on the vehicle used for vehicle movement adjustment.

6. The transportation system according to claim 1 further including: Personal universes (zones) that are independent of other zones or transportation system that become wish to be incorporated into or separated from the transportation universe.

7. The transportation system according to claim 1 further including: All vehicle movements are separated, aggregated, given direction ,given speed, assigned routes solely by the transportation universe by means of two way communication and known contents and boundaries under the central controlled as planned, computed, controlled by the controlling function Fn(xi,yi,zi,fi,ti, . . . ).

8. The transportation system according to claim 1 further including: All vehicles no longer requiring a driver or pilot, may have interior occupancy space configured to novel uses known to and adjusted for by the central control.
